(19) United States
(12) Patent Application Publication
(10) Pub. No.: US 2008/0232282 A1
(43) Pub. Date: Sep. 25, 2008

(54) SMART ACCUMULATOR FOR FINITE-PRECISION ARITHMETIC

(75) Inventors: Ming-Chang Tsai, San Diego, CA (US); Pillappakkam Srinivas, San Diego, CA (US); Ric Senior, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/052,340

(22) Filed: Mar. 20, 2008

Related U.S. Application Data
(60) Provisional application No. 60/896,041, filed on Mar. 21, 2007.

(51) Int. Cl. H04B 7/00

(52) U.S. Cl. 370/310

(57) ABSTRACT

Systems, methods, and devices that facilitate finite-precision data accumulation by utilizing precision binning and queuing are provided. A precision range of a data element received into a queue can be determined. Further, a stored data element of like precision can be selected. The stored data element can be added with the data element received into the queue to generate a resultant data element. The resultant data element can be stored in a memory location or the queue as a function of like precision range.

### CLAIM OF PRIORITY UNDER 35 U.S.C. §119

This application claims priority to U.S. Provisional Patent Application Ser. No. 60/896,041 entitled “SMART ACCUMULATOR FOR FINITE-PRECISION ARITHMETIC,” which was filed Mar. 21, 2007. The entirety of the aforementioned application is herein incorporated by reference.

### BACKGROUND

I. Field

The following description relates generally to communications systems, and more particularly, to data accumulation for finite-precision arithmetic.

II. Background

Communication systems are widely deployed to provide various types of communication content such as voice, data, etc. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

MIMO systems commonly employ multiple (N_{T}) transmit antennas and multiple (N_{R}) receive antennas for data transmission. A MIMO channel formed by the N_{T} transmit and N_{R} receive antennas may be decomposed into N_{S} independent channels, which may be referred to as spatial channels, where N_{S}≦{N_{T},N_{R}}. Each of the N_{S} independent channels corresponds to a dimension. Moreover, MIMO systems may provide improved performance (e.g., increased spectral efficiency, higher throughput and/or greater reliability) if the additional dimensionalities created by the multiple transmit and received antennas are utilized.

MIMO systems may support various duplexing techniques to divide forward and reverse link communications over a common physical medium. For instance, frequency division duplex (FDD) systems may utilize disparate frequency regions for forward and reverse link communications. Further, in time division duplex (TDD) systems, forward and reverse link communications may employ a common frequency region.

Electronic devices of communication systems typically employ some form of computer arithmetic. Summation of data sequences, i.e., data accumulation, is commonly used in a wide variety of computer arithmetic applications, e.g., modem, multimedia, and/or wireless communication system design and implementation. Due to limited computing resources, data accumulation typically utilizes finite-precision arithmetic involving floating-point and fixed-point data.

One traditional solution for performing finite-precision data accumulation, illustrated by FIG. 11, is linear data accumulation, in which data is accumulated in the order that it arrives. A disadvantage of linear data accumulation is that data precision reduces as more data is accumulated. For example, results obtained by a data accumulator summing a sequence of N-bit numerical values would be constrained to N bits of precision. When the result of a sequence of data summations becomes sufficiently large, the range of precision must be reduced so that only the N most significant bits fall within the precision range; therefore, portions of the input data sequence composed of less significant bits may not be accounted for.

Another traditional solution for performing finite-precision data accumulation, illustrated by FIG. 12, is hierarchical data accumulation, in which data is accumulated in pairs and stages. Although well suited for certain applications, e.g., Fast Fourier Transform, hierarchical data accumulation suffers from similar pitfalls of linear data accumulation because two data elements accumulated at a particular stage may be added with incompatible precision ranges; therefore, portions of the result of the accumulation composed of less significant bits may not be accounted for.

Yet another traditional solution for performing finite-precision data accumulation, illustrated by FIG. 13, is progressive data accumulation, in which data within a similar precision range is accumulated. Although progressive data accumulation provides increased accuracy, it requires significant computational complexity due to necessary data buffering and sorting.

It is therefore desirable to have systems and methods that achieve the benefits of both linear accumulation and progressive accumulation in performing finite-precision arithmetic, i.e., minimal computational complexity and improved accuracy.

### SUMMARY

The claimed subject matter relates to systems, methods, and devices for optimizing data accumulation for finite-precision arithmetic. Traditional linear and hierarchal data accumulation methods are limited by reduced accuracy accompanying large sequences of data summations. Further, although progressive data accumulation, unlike linear and hierarchical data accumulation, increases the accuracy of data summations, progressive data accumulation requires complex data buffering and sorting to perform computations.

Compared to traditional data accumulation technology, the novel systems, methods, and devices of the claimed subject matter improve computation accuracy and performance of data accumulation, while minimizing computation complexity, by utilizing precision range binning and queuing. In particular, the claimed subject matter provides for finite-precision data accumulation that combines the convenience of linear data accumulation with the performance of progressive data accumulation by utilizing a queue to hold data to be accumulated, multiple registers for binning to separate intermediate accumulated results by precision range, and adding and storing data a as function of like precision range.

The following presents a simplified summary of the innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

The subject invention provides systems, methods, and devices for improving the accuracy of finite-precision data accumulation while minimizing computation complexity by utilizing precision range binning and queuing. In accordance with one aspect of the disclosed subject matter, a method can determine a precision range of a data element received into a queue. Further, the method can select a stored data element of like precision range. The stored data element can be added with the data element received into the queue to generate a resultant data element, wherein the resultant data element can be stored as a function of like precision range.

In accordance with another aspect of the disclosed subject matter, a wireless communication apparatus can include an evaluator that determines a precision range of a data element received into a queue. Additionally, the wireless communication apparatus can include a selector that selects a stored data element of like precision range, wherein the stored data element is added with the data element received into the queue to generate a resultant data element. The resultant data element may be stored as a function of like precision range.

In accordance with yet another aspect of the disclosed subject matter, a wireless communication apparatus can include means for determining a precision range of a data element received into a queue. Moreover, the wireless communication apparatus can include means for selecting a stored data element of like precision range. The stored data element can be added with the data element received into the queue to generate a resultant data element. Additionally, the resultant data element can be stored as a function of like precision range.

In accordance with one aspect of the disclosed subject matter, a machine-readable medium can have stored thereon machine-executable instructions for determining a precision range of a data element received into a queue. Further, the machine readable medium can have stored thereon machine-executable instructions for selecting a stored data element of like precision range, wherein the stored data element is added with the data element received into the queue to generate a resultant data element. The resultant data element can be stored as a function of like precision range.

In accordance with another aspect of the disclosed subject matter, a wireless communication apparatus can include a processor configured to determine a precision range of a data element received into a queue. Moreover, the processor can be configured to select a stored data element of like precision range, wherein the stored data element can be added with the data element received into the queue to generate a resultant data element. Additionally, the resultant data element can be stored as a function of like precision range.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a wireless communication system, in accordance with an embodiment of the invention.

FIG. 2 illustrates a demonstrative smart accumulator system that facilitates finite-precision data accumulation, in accordance with an embodiment of the invention.

FIG. 3 illustrates another demonstrative smart accumulator system that facilitates finite-precision data accumulation, in accordance with an embodiment of the invention.

FIG. 4 illustrates a block diagram of a smart accumulator that facilitates finite-precision data accumulation, in accordance with an embodiment of the invention.

FIG. 5 illustrates a flow chart of a smart accumulator methodology that facilitates finite-precision data accumulation, in accordance with an embodiment of the invention.

FIG. 6 illustrates a flow chart of another smart accumulator methodology that facilitates finite-precision data accumulation, in accordance with an embodiment of the invention.

FIG. 7 illustrates an example mobile device that facilitates finite-precision data accumulation, in accordance with an embodiment of the invention.

FIG. 8 illustrates an example system that facilitates finite-precision data accumulation, in accordance with an embodiment of the invention.

FIG. 9 illustrates an example wireless network environment that can be employed in conjunction with the various systems and methods described herein.

FIG. 10 illustrates an example system that facilitates finite-precision data accumulation, in accordance with an embodiment of the invention.

FIG. 11 illustrates the operation of a traditional linear accumulator on a data sequence.

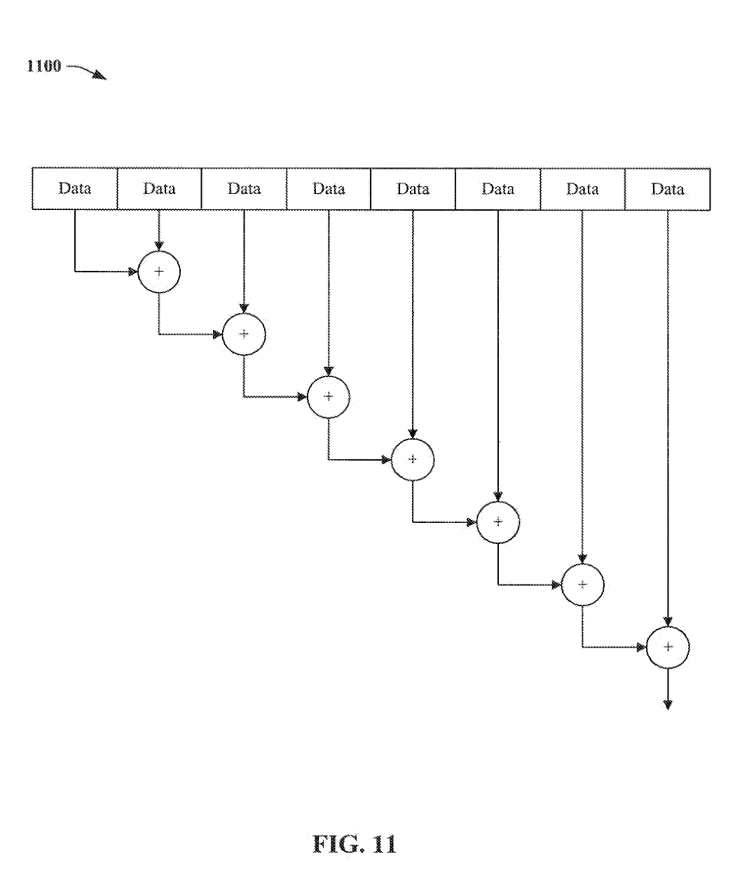

FIG. 12 illustrates the operation of a traditional hierarchical accumulator on a data sequence.

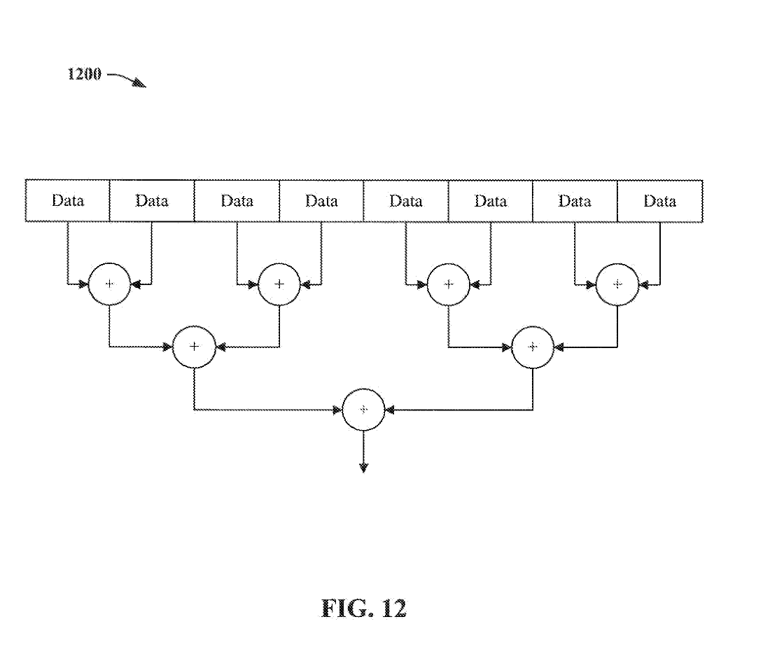

FIG. 13 illustrates the operation of a traditional progressive accumulator on a data sequence.

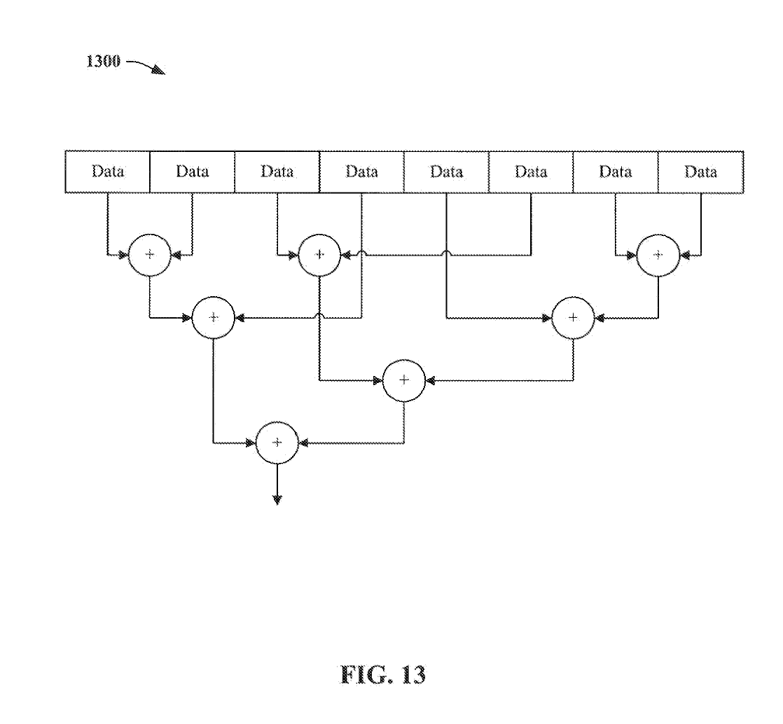

### DETAILED DESCRIPTION

The techniques described herein may be used for various wireless communication systems such as Code Division Multiple Access (CDMA), Time division multiple access (TDMA), Frequency Division Multiple Access (FDMA), Orthogonal Frequency-Division Multiple Access (OFDMA), Single Carrier FDMA (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards.

A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2).

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device may be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station may be utilized for communicating with mobile device(s) and may also be referred to as an access point, Node B, or some other terminology.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

Various embodiments will be presented in terms of systems that may include a number of components, modules, and the like. It is to be understood and appreciated that the various systems may include additional components, modules, etc. and/or may not include all of the components, module, etc., discussed in connection with the figures. A combination of these approaches may also be used.

Additionally, while embodiments are generally described with respect to a communications system, those skilled in the art will recognize that the embodiments can be applied to any design employing finite-precision arithmetic, including both fixed-point and floating-point data representations. It is to be appreciated that the systems and/or methods described herein can be employed with any suitable type of design and all such types of design(s) are intended to fall within the scope of the hereto appended claims.

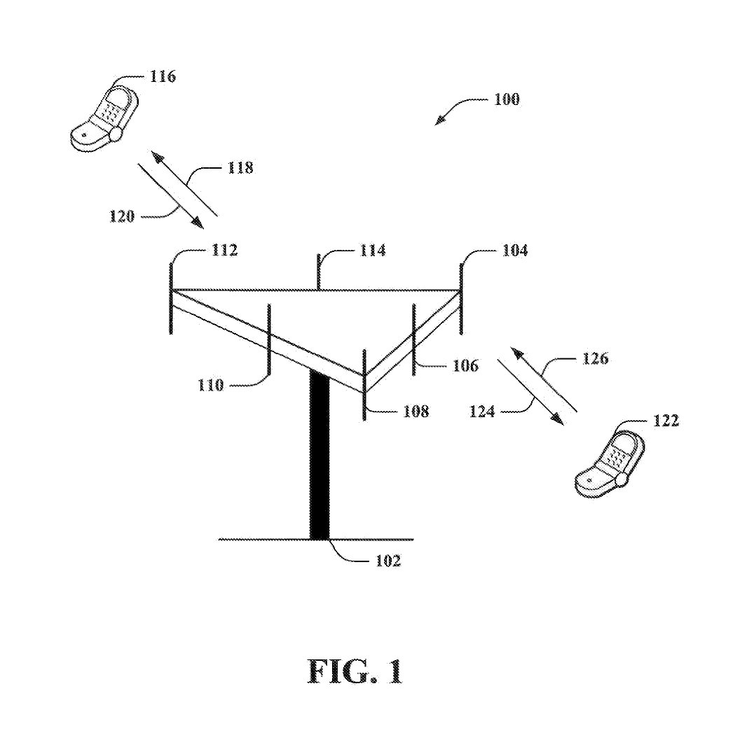

Referring now to FIG. 1, a wireless communication system 100 is illustrated in accordance with various embodiments presented herein. System 100 comprises a base station 102 that may include multiple antenna groups. For example, one antenna group may include antennas 104 and 106, another group may comprise antennas 108 and 110, and an additional group may include antennas 112 and 114. Two antennas are illustrated for each antenna group; however, more or fewer antennas may be utilized for each group. Base station 102 may additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 may communicate with one or more mobile devices such as mobile device 116 and mobile device 122; however, it is to be appreciated that base station 102 may communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120.

Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 may utilize a different frequency band than that used by reverse link 120, and forward link 124 may employ a different frequency band than that employed by reverse link 126, for example. Further, in a time division duplex (TDD) system, forward link 118 and reverse link 120 may utilize a common frequency band and forward link 124 and reverse link 126 may utilize a common frequency band.

The set of antennas and/or the area in which they are designated to communicate may be referred to as a sector of base station 102. For example, multiple antennas may be designed to communicate to mobile devices in a sector of the areas covered by base station 102. In communication over forward links 118 and 124, the transmitting antennas of base station 102 may utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells may be subject to less interference as compared to a base station transmitting through a single antenna to all its mobile devices.

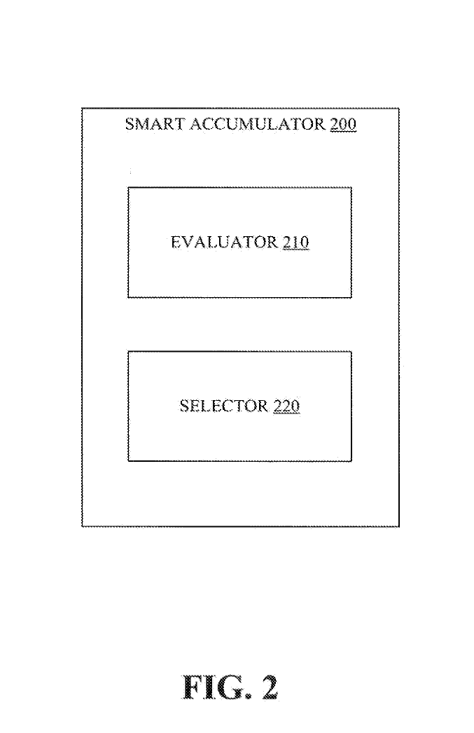

Referring to FIG. 2, a demonstrative smart accumulator system 200 that facilitates finite-precision data accumulation in accordance with an embodiment of the invention is illustrated. As described above, computer arithmetic such as data accumulation is typically constrained to a finite amount of precision due to limited computing resources. Further, conventional methods of finite-precision data accumulation, e.g., linear and hierarchical data accumulation, can be indeterministic as a sequence of data elements to be summed grows sufficiently large. In addition, although conventional methods, e.g., progressive data accumulation, may account for such loss of precision by buffering and sorting data, such operations involve significant computational complexity and consume valuable computational resources.

Unlike conventional data accumulation technology, the novel smart accumulator system 200 illustrated by FIG. 2 utilizes precision range binning and queuing to increase the precision of data accumulation and reduce computational complexity. An evaluator 210 can perform precision range queuing by determining a precision range of a data element received into a queue; the queue can hold input and intermediate data awaiting accumulation. Further, a selector 220 can select a stored data element of like precision range, and the stored data element can be added with the data element received into the queue to generate a resultant data element. System 200 can perform precision range binning by storing the resultant data element as a function of like precision range, that is, system 200 can separate intermediate accumulated results of different precision ranges by storing such results in memory locations of like precision range.

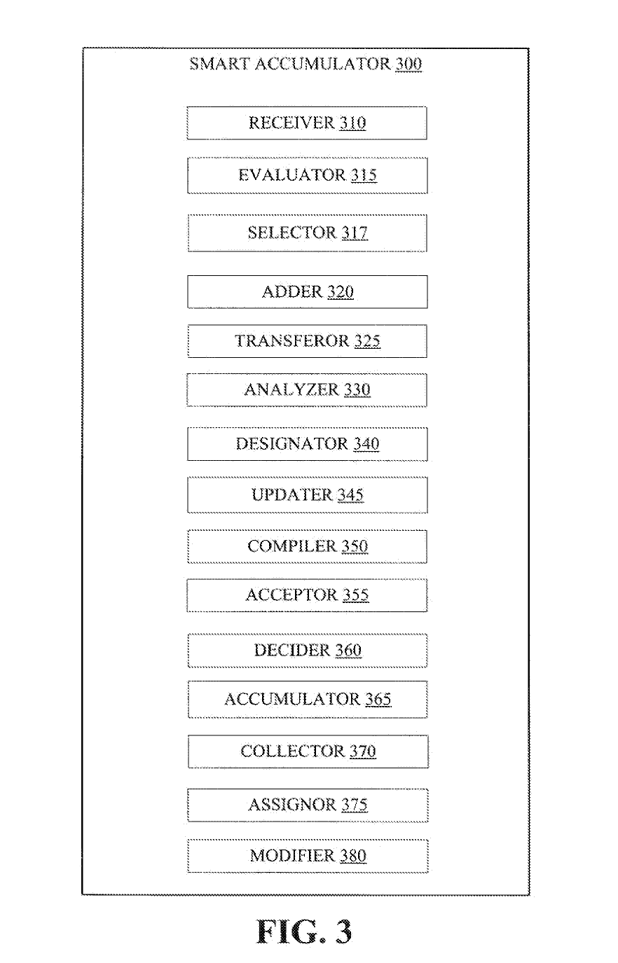

Now referring to FIG. 3, another demonstrative smart accumulator system that facilitates finite-precision data accumulation in accordance with an embodiment of the invention is illustrated. A receiver 310 can receive a data element into a queue, while evaluator 315 can determine the precision range of the data element. Selector 317 can select a stored data element of like precision range, while an adder 320 can add the received data element with the stored data element to generate a resultant data element. A transferor 325 can store the resultant data element in a memory location of like precision range when a state indicator of the memory location is not set, or transfer the resultant data element to the queue.

Further, an analyzer 330 can determine whether the state indicator of the memory location of like precision range is set. In another embodiment, the state indicator can be set by a designator 340 after data is stored in the memory location. In yet another embodiment, an updater 345 can clear the state indicator of the memory location after the resultant data element stored in the memory location is added with the data element received into the queue. In one embodiment, the data element received into the queue can include one or more input data elements and one or more resultant data elements. In another embodiment, a compiler 350 can add one of the one or more input data elements or one of the one or more resultant data elements from a head of the queue with the stored resultant data element of like precision range until the queue is empty.

Thus, system 300 achieves the advantages of conventional linear and progressive data accumulation, while avoiding the disadvantages of such conventional techniques, by utilizing a queue to hold data to be accumulated, using multiple memory locations for binning to separate intermediate accumulated results by precision range, and adding and storing data as a function of like precision range.

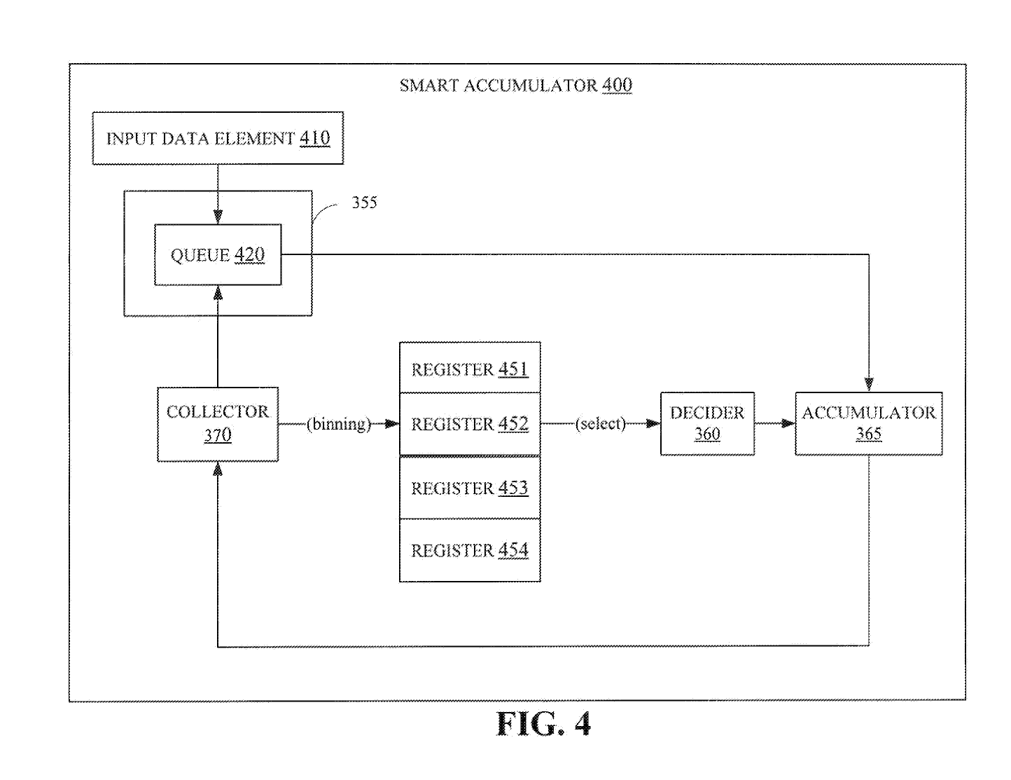

Now referring to FIG. 4, a block diagram of a smart accumulator 400 that facilitates finite-precision data accumulation in accordance with an embodiment of the invention is illustrated. With additional reference to FIG. 3, an acceptor 355 can receive one or more input data elements 410 and one or more resultant data elements at an end of a queue 420. A decider 360 can select a stored resultant data element from a register (e.g., 451, 452, 453, or 454) of like precision range. Further, an accumulator 365 can add one of the one or more input data elements or one of the one or more resultant data elements from a head of queue 420 with the selected stored data element of like precision range to generate the resultant data element. A collector 370 can store the resultant data element in a register of like precision range (e.g., 451, 452, 453, or 454) to perform precision range binning when a status bit of the register is not set, or can transfer the resultant data element to queue 420.

Moreover, an assignor 375 can set the status bit of the register after the resultant data element is stored in the register. Further, a modifier 380 can clear the status bit of the register after one of the one or more input data elements or one of the one or more resultant data elements from the head of the queue is added with the resultant data element that was stored in the register. In addition, it is to be appreciated that under some embodiments, the end result obtained by smart accumulator 400 will be more accurate and deterministic if the capacity of storage is increased, e.g., more registers of different precision ranges are added.

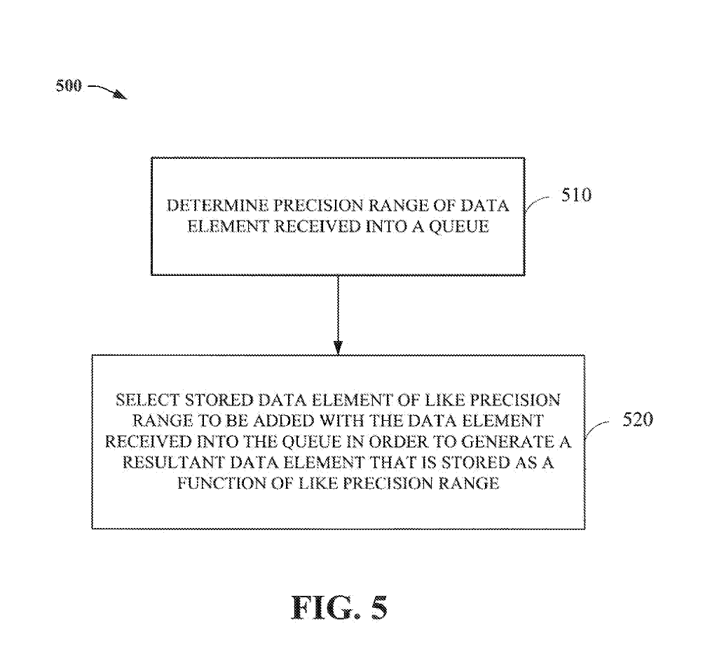

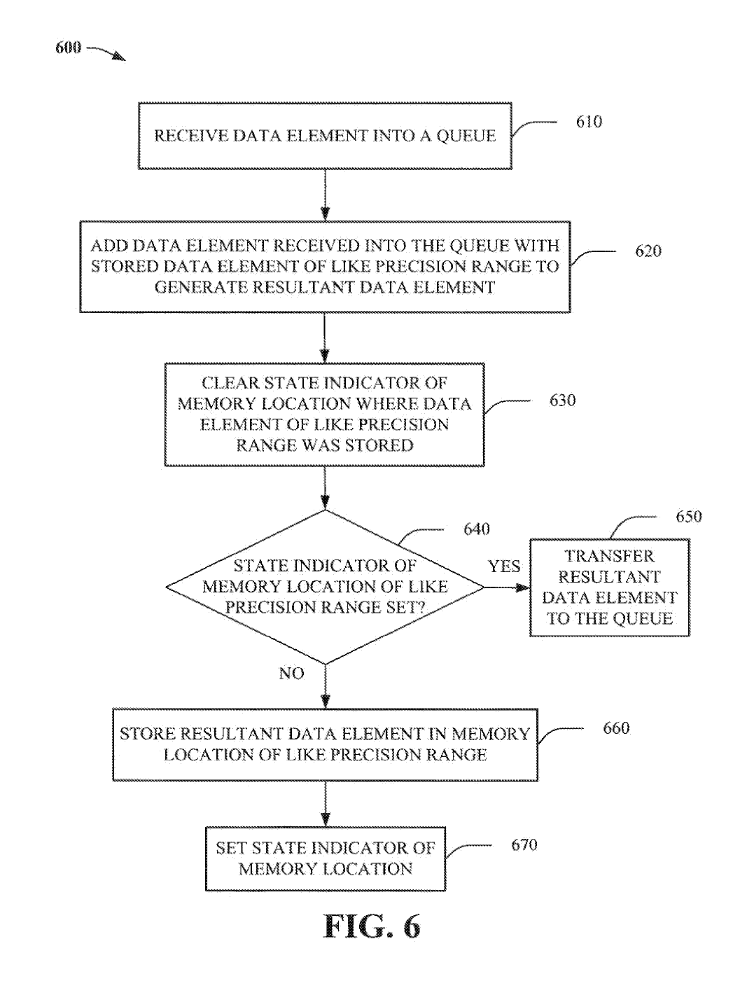

Referring to FIGS. 5-6, methodologies relating to facilitating finite-precision data accumulation in accordance with embodiments of the invention are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Referring now to FIG. 5, an example smart accumulator methodology 500 is disclosed for facilitating finite-precision data accumulation, in accordance with an embodiment of the invention. As described above, conventional methods for performing finite-precision data accumulation, which accumulate data in the order that it arrives, e.g., linear and hierarchical data accumulation, can be indeterministic as a sequence of data elements to be summed grows sufficiently large. Further, although conventional methods, e.g., progressive data accumulation, can account for such loss of precision by buffering and sorting data of similar precision range, such operations involve significant computational complexity and consume valuable resources—data sequences to be accumulated must be repeatedly buffered and sorted after each individual addition.

Unlike conventional data accumulation methods, the novel smart accumulator methodology 500, illustrated by FIG. 5, utilizes precision range binning and queuing to increase the precision of data accumulation and reduce computational complexity. At 510, in which precision range queuing results, a determination can be made as to the precision range of a data element received into a queue. Unlike conventional linear accumulation, which weighs data elements accumulated early in a data sequence more than data elements accumulated late in the data sequence, and unlike hierarchical accumulation, in which the precision range of different data pairs may not expand at the same pace, accumulator methodology 500 queues input and intermediate data in order to accumulate data of like precision range.

At 520, a stored data element of like precision range to be added with the data element received into the queue is selected, in order to generate a resultant data element to be stored as a function of like precision range. Precision range binning is performed by storing intermediate accumulated results of different precision ranges in memory locations corresponding to the precision range of the accumulated results. Thus, accumulator methodology 500 avoids the pitfalls of progressive accumulation (e.g., significant computational complexity) by receiving and holding data in a queue in order to accumulate data of like precision range.

Referring now to FIG. 6, another example methodology is disclosed for facilitating finite-precision data accumulation, in accordance with an embodiment of the invention. At 610, a data element can be received into a queue. In one embodiment, one or more input data elements and one or more resultant data elements can be received at an end of the queue. At 620, the data element can be added with a selected stored data element of like precision range to generate a resultant data element. In another embodiment, one of the one or more input data elements or one of the one or more resultant data elements from a head of the queue can be added with the selected stored data element of like precision range to generate the resultant data element. In yet another embodiment, a state indicator of a memory location where the selected data element of like precision was stored can be cleared at 630. In one embodiment, the status bit of a register can be cleared after one of the one or more input data elements or one of the one or more resultant data elements from the head of the queue was added with the selected data element stored in the register.

A determination can be made at 640 as to whether a state indicator of a memory location of like precision range (that is, a precision range similar to the precision range of the resultant data element) is set. If the state indicator is set, the resultant data element can be transferred to the queue at 650. If the state indicator is not set, the resultant data element can be stored in a memory location of like precision range at 660. In another embodiment, the resultant data element can be stored in a register of like precision range when a status bit of the register is not set, or transferred to the queue. At 670, the state indicator of the memory location (e.g., status bit of the register) can be set.

Thus, methodology 600 achieves the advantages of conventional linear and progressive data accumulation, while avoiding the disadvantages of such conventional techniques, by receiving data to be accumulated into queue, utilizing multiple memory locations for binning to separate intermediate accumulated results by precision range, and adding and storing data as a function of like precision range.

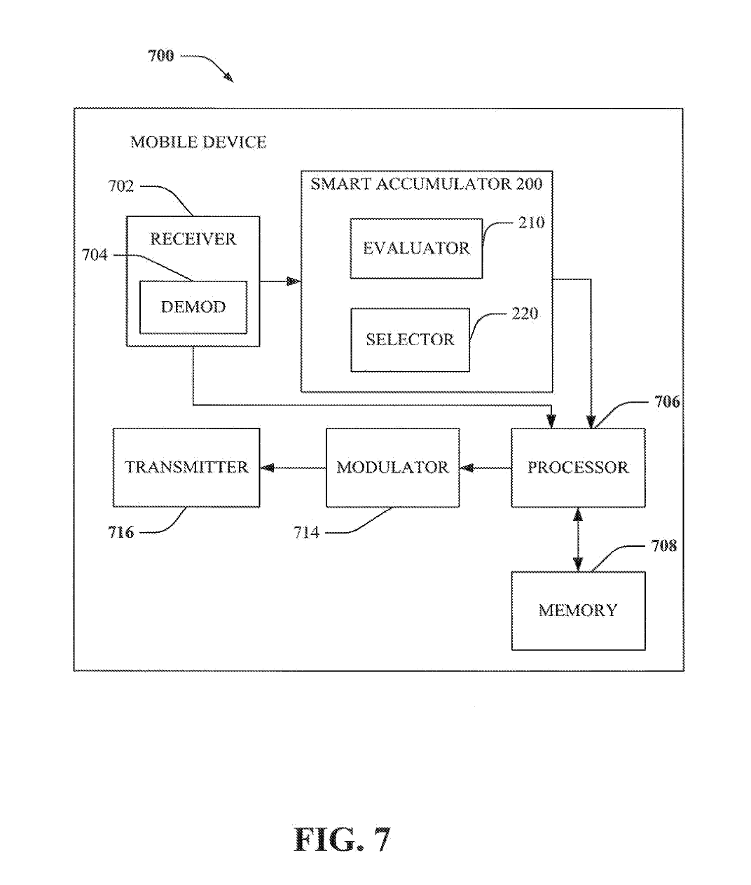

FIG. 7 is an illustration of a mobile device 700 that facilitates finite-precision data accumulation, in accordance with an embodiment of the invention. Mobile device 700 comprises a receiver 702 that receives a signal from, for instance, a receive antenna (not shown), and performs typical actions thereon (e.g., filters, amplifies, downconverts, etc.) the received signal and digitizes the conditioned signal to obtain samples. Receiver 702 can be, for example, an MMSE receiver, and can comprise a demodulator 704 that can demodulate received symbols and provide them to a processor 706 for channel estimation. Processor 706 can be a processor dedicated to analyzing information received by receiver 702 and/or generating information for transmission by a transmitter 716, a processor that controls one or more components of mobile device 700, and/or a processor that both analyzes information received by receiver 702, generates information for transmission by transmitter 716, and controls one or more components of mobile device 700.

Mobile device 700 can additionally comprise memory 708 that is operatively coupled to processor 706 and that may store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.). Additionally, the memory 708 may store executable code and/or instructions. For example, the memory 708 may store instructions for determining a precision range of a data element received into a queue. Further, the memory 708 may store instructions for selecting a stored data element of like precision range, wherein the stored data element is added with the data element received into the queue to generate a resultant data element, the resultant data element stored as a function of like precision range.

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 708 of the subject systems and methods is intended to comprise, without being limited to, these and any other suitable types of memory.

Processor 706 is further operatively coupled to a smart accumulator 200, in which an evaluator 210 can determine a precision range of a data element received into a queue and a selector 220 can select a stored data element of like precision range, wherein the stored data element can be added with the data element received into the queue to generate a resultant data element, the resultant data element stored as a function of like precision range. The evaluator 210 and/or selector 220 may include aspects as described above with reference to FIGS. 2-6. Mobile device 700 may further comprise a modulator 714 and a transmitter 716 that transmits a signal (e.g., base CQI and differential CQI) to, for instance, a base station, another mobile device, etc. Although depicted as being separate from the processor 706, it is to be appreciated that evaluator 210 and/or selector 220 may be part of processor 706 or a number of processors (not shown).

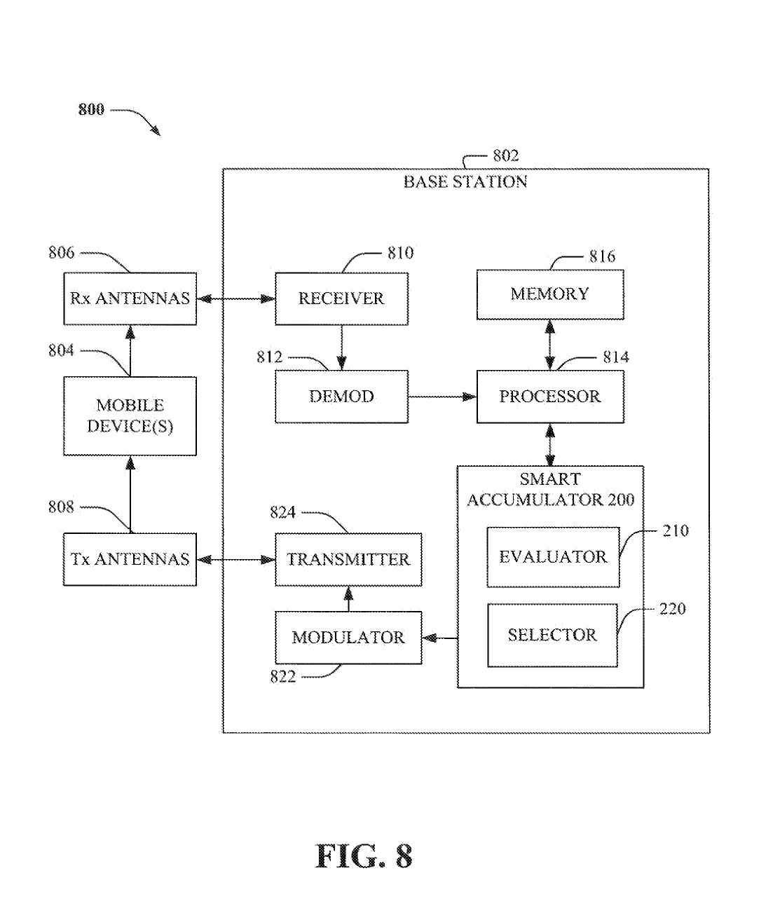

FIG. 8 is an illustration of an example system 800 that facilitates finite-precision data accumulation, in accordance with an embodiment of the invention. System 800 comprises a base station 802 (e.g., access point, . . . ) with a receiver 810 that receives signal(s) from one or more mobile devices 804 through a plurality of receive antennas 806, and a transmitter 822 that transmits to the one or more mobile devices 804 through a plurality of transmit antennas 808. Receiver 810 can receive information from receive antennas 806 and is operatively associated with a demodulator 812 that demodulates received information. Demodulated symbols are analyzed by a processor 814 that can be similar to the processor described above with regard to FIG. 7, and which is coupled to a memory 816 that stores information related to estimating a signal (e.g., pilot) strength and/or interference strength, data to be transmitted to or received from mobile device(s) 804 (or a disparate base station (not shown)), and/or any other suitable information related to performing the various actions and functions set forth herein.

Processor 814 is further coupled to a smart accumulator 220, in which an evaluator 210 can determine a precision range of a data element received into a queue and a selector 220 can select a stored data element of like precision range, wherein the stored data element can be added with the data element received into the queue to generate a resultant data element, the resultant data element stored as a function of like precision range. The evaluator 210 and/or selector 220 may include aspects as described above with reference to FIGS. 2-6. Information to be transmitted may be provided to a modulator 822. Modulator 822 can multiplex the information for transmission by a transmitter 824 through antenna 808 to mobile device(s) 804. Although depicted as being separate from the processor 814, it is to be appreciated that evaluator 818 and/or selector 820 may be part of processor 814 or a number of processors (not shown).

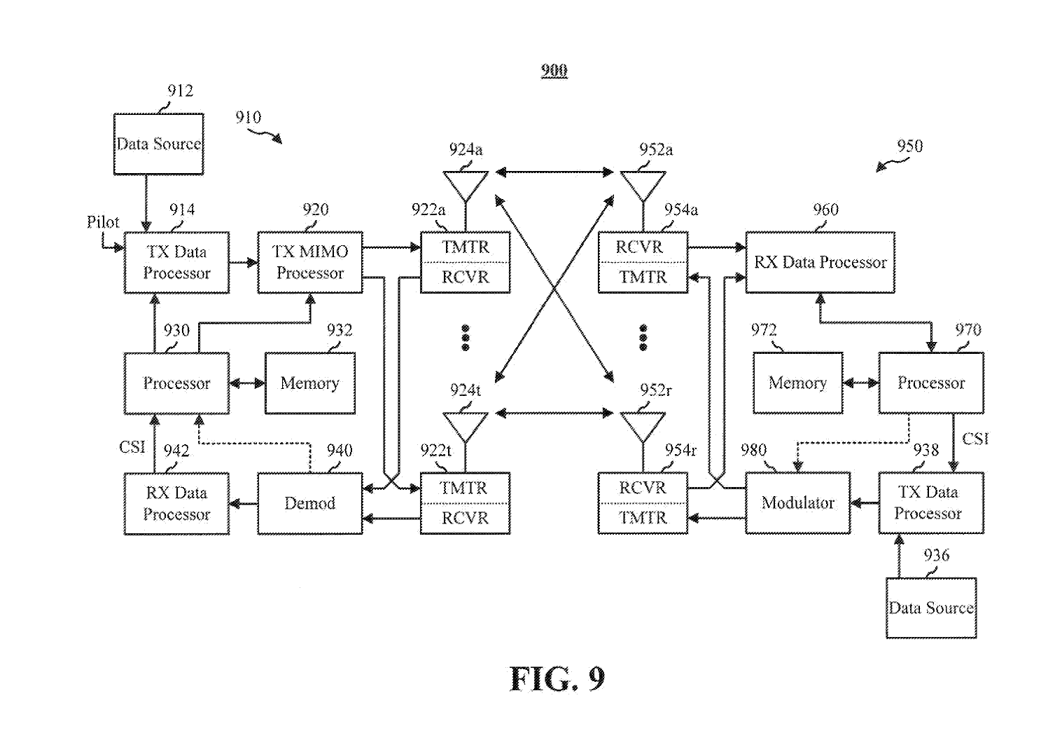

FIG. 9 shows an example wireless communication system 900. The wireless communication system 900 depicts one base station 910 and one mobile device 950 for sake of brevity. However, it is to be appreciated that system 900 may include more than one base station and/or more than one mobile device, wherein additional base stations and/or mobile devices may be substantially similar or different from example base station 910 and mobile device 950 described below. In addition, it is to be appreciated that base station 910 and/or mobile device 950 may employ the systems (FIGS. 1-4 and 7-8) and/or methods (FIGS. 5-6) described herein to facilitate wireless communication there between.

At base station 910, traffic data for a number of data streams is provided from a data source 912 to a transmit (TX) data processor 914. According to an example, each data stream may be transmitted over a respective antenna. TX data processor 914 formats, codes, and interleaves the traffic data stream based on a particular coding scheme selected for that data stream to provide coded data.

The coded data for each data stream may be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and may be used at mobile device 950 to estimate channel response. The multiplexed pilot and coded data for each data stream may be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream may be determined by instructions performed or provided by processor 930.

The modulation symbols for the data streams may be provided to a TX MIMO processor 920, which may further process the modulation symbols (e.g., for OFDM). TX MIMO processor 920 then provides N_{T} modulation symbol streams to N_{T} transmitters (TMTR) 922a through 922t. In various embodiments, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 may receive and process the N_{R} received symbol streams from N_{R} receivers 954 based on a particular receiver processing technique to provide N_{T} “detected” symbol streams. RX data processor 960 may demodulate, deinterleave, and decode each detected symbol stream to recover the traffic data for the data stream. The processing by RX data processor 960 is complementary to that performed by TX MIMO processor 920 and TX data processor 914 at base station 910.

A processor 970 may periodically determine which precoding matrix to utilize as discussed above. Further, processor 970 may formulate a reverse link message comprising a matrix index portion and a rank value portion.

The reverse link message may comprise various types of information regarding the communication link and/or the received data stream. The reverse link message may be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 may process the extracted message to determine which precoding matrix to use for determining the beamforming weights.

Processors 930 and 970 may direct (e.g., control, coordinate, manage, etc.) operation at base station 910 and mobile device 950, respectively. Respective processors 930 and 970 can be associated with memory 932 and 972 that store program codes and data. Processors 930 and 970 can also perform computations to derive frequency and impulse response estimates for the uplink and downlink, respectively.

It is to be understood that the embodiments described herein may be implemented in hardware, software, firmware, middleware, microcode, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof

When the embodiments are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

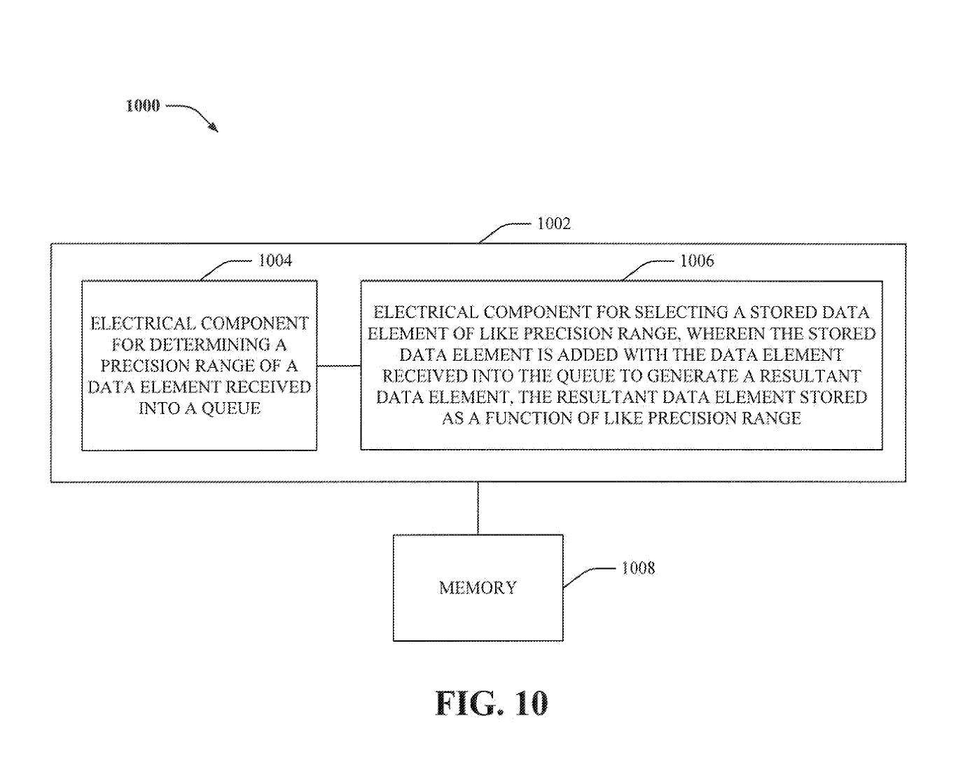

With reference to FIG. 10, illustrated is an example system that facilitates finite-precision data accumulation, in accordance with an embodiment of the invention. For example, system 1000 may reside at least partially within a mobile device. It is to be appreciated that system 1000 is represented as including functional blocks, which may be functional blocks that represent functions implemented by a processor, software, or combination thereof (e.g., firmware). System 1000 includes a logical grouping 1002 of electrical components that can act in conjunction.

For instance, logical grouping 1002 may include an electrical component 1004 for determining a precision range of a data element received into a queue. Further, logical grouping 1002 may comprise an electrical component 1006 for selecting a stored data element of like precision range, wherein the stored data element can be added with the data element received into the queue to generate a resultant data element, the resultant data element stored as a function of like precision range. Additionally, system 1000 may include a memory 1008 that retains instructions for executing functions associated with electrical components 1004 and 1006. While shown as being external to memory 1008, it is to be understood that one or more of electrical components 1004 and 1006 may exist within memory 1008.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method comprising:
determining a precision range of a data element received into a queue; and
selecting a stored data element of like precision range, wherein the stored data element is added with the data element received into the queue to generate a resultant data element, the resultant data element stored as a function of like precision range.

2. The method of claim 1, further comprising:
receiving the data element into the queue;
adding the data element received into the queue with the stored data element of like precision range to generate the resultant data element;
determining whether a state indicator of a memory location of like precision range is set, wherein the state indicator is set after data is stored in the memory location; and
storing the resultant data element in the memory location of like precision range when the state indicator of the memory location is not set, or transferring the resultant data element to the queue.

3. The method of claim 2, further comprising:
setting the state indicator of the memory location after the resultant data element is stored in the memory location; and
clearing the state indicator of the memory location after the resultant data element stored in the memory location is added with the data element received into the queue.

4. The method of claim 3, wherein the data element received into the queue comprises one or more input data elements and one or more resultant data elements.

5. The method of claim 4, further comprising:
receiving the one or more input data elements and the one or more resultant data elements at an end of the queue.

6. The method of claim 5, further comprising:
adding one of the one or more input data elements or one of the one or more resultant data elements from a head of the queue with the selected stored data element of like precision range to generate the resultant data element.

7. The method of claim 6, further comprising:
storing the resultant data element in a register of like precision range when a status bit of the register is not set, or transferring the resultant data element to the queue.

8. The method of claim 7, further comprising:
setting the status bit of the register after the resultant data element is stored in the register; and
clearing the status bit of the register after one of the one or more input data elements or one of the one or more resultant data elements from the head of the queue is added with the resultant data element that was stored in the register.

9. The method of claim 8, further comprising:
selecting the resultant data element stored in the register of like precision range, wherein the selected resultant data element is added with one of the one or more input data elements or one or more resultant data elements from the head of the queue.

10. The method of claim 9, further comprising:
adding one of the one or more input data elements or one of the one or more resultant data elements from a head of the queue with the stored resultant data element of like precision range until the queue is empty.

11. A wireless communication apparatus comprising:
an evaluator that determines a precision range of a data element received into a queue; and
a selector that selects a stored data element of like precision range, wherein the stored data element is added with the data element received into the queue to generate a resultant data element, the resultant data element stored as a function of like precision range.

12. The apparatus of claim 11, further comprising:
a receiver that receives the data element into the queue;
an adder that adds the data element received into the queue with the stored data element of like precision range to generate the resultant data element;
an analyzer that determines whether a state indicator of a memory location of like precision range is set, wherein the state indicator is set after data is stored in the memory location; and
a transferor that stores the resultant data element in the memory location of like precision range when the state indicator of the memory location is not set, or transfers the resultant data element to the queue.

13. The apparatus of claim 12, further comprising:
a designator that sets the state indicator of the memory location after the resultant data element is stored in the memory location; and
an updater that clears the state indicator of the memory location after the resultant data element stored in the memory location is added with the data element received into the queue.

14. The apparatus of claim 13, wherein the data element received into the queue comprises one or more input data elements and one or more resultant data elements.

15. The apparatus of claim 14, further comprising:
an acceptor that receives the one or more input data elements and the one or more resultant data elements at an end of the queue.

16. The apparatus of claim 15, further comprising:
an accumulator that adds one of the one or more input data elements or one of the one or more resultant data elements from a head of the queue with the selected stored data element of like precision range to generate the resultant data element.

17. The apparatus of claim 16, further comprising:
a collector that stores the resultant data element in a register of like precision range when a status bit of the register is not set, or transfers the resultant data element to the queue.

18. The apparatus of claim 17, further comprising:
an assignor that sets the status bit of the register after the resultant data element is stored in the register; and
a modifier that clears the status bit of the register after one of the one or more input data elements or one of the one or more resultant data elements from the head of the queue is added with the resultant data element that was stored in the register.

19. The apparatus of claim 18, further comprising:
a decider that selects the resultant data element stored in the register of like precision range, wherein the selected resultant data element is added with one of the one or more input data elements or one or more resultant data elements from the head of the queue.

20. The apparatus of claim 19, further comprising:
a compiler that adds one of the one or more input data elements or one of the one or more resultant data elements from a head of the queue with the stored resultant data element of like precision range until the queue is empty.

21. A wireless communications apparatus comprising:
means for determining a precision range of a data element received into a queue; and
means for selecting a stored data element of like precision range, wherein the stored data element is added with the data element received into the queue to generate a resultant data element, the resultant data element stored as a function of like precision range.

22. The apparatus of claim 21, further comprising:
means for receiving the data element into the queue;
means for adding the data element received into the queue with the stored data element of like precision range to generate the resultant data element;
means for determining whether a state indicator of a memory location of like precision range is set, wherein the state indicator is set after data is stored in the memory location; and
means for storing the resultant data element in the memory location of like precision range when the state indicator of the memory location is not set, or transferring the resultant data element to the queue.

23. The apparatus of claim 22, further comprising:
means for setting the state indicator of the memory location after the resultant data element is stored in the memory location; and
means for clearing the state indicator of the memory location after the resultant data element stored in the memory location is added with the data element received into the queue.

24. The apparatus of claim 23, wherein the data element received into the queue comprises one or more input data elements and one or more resultant data elements.

25. The apparatus of claim 24, further comprising:
means for receiving the one or more input data elements and the one or more resultant data elements at an end of the queue.

26. The apparatus of claim 25, further comprising:
means for adding one of the one or more input data elements or one of the one or more resultant data elements from a head of the queue with the selected stored data element of like precision range to generate the resultant data element.

27. The apparatus of claim 26, further comprising:
means for storing the resultant data element in a register of like precision range when a status bit of the register is not set, or transferring the resultant data element to the queue.

28. The apparatus of claim 27, further comprising:
means for setting the status bit of the register after the resultant data element is stored in the register; and
means for clearing the status bit of the register after one of the one or more input data elements or one of the one or more resultant data elements from the head of the queue is added with the resultant data element that was stored in the register.

29. The apparatus of claim 28, further comprising:
means for selecting the resultant data element stored in the register of like precision range, wherein the selected resultant data element is added with one of the one or more input data elements or one or more resultant data elements from the head of the queue.

30. The apparatus of claim 29, further comprising:
means for adding one of the one or more input data elements or one of the one or more resultant data elements from a head of the queue with the stored resultant data element of like precision range until the queue is empty.

31. A machine-readable medium having stored thereon machine-executable instructions for:
determining a precision range of a data element received into a queue; and
selecting a stored data element of like precision range, wherein the stored data element is added with the data element received into the queue to generate a resultant data element, the resultant data element stored as a function of like precision range.

32. The machine-readable medium of claim 31, further comprising instructions for:
receiving the data element into the queue;
adding the data element received into the queue with the stored data element of like precision range to generate the resultant data element;
determining whether a state indicator of a memory location of like precision range is set, wherein the state indicator is set after data is stored in the memory location; and
storing the resultant data element in the memory location of like precision range when the state indicator of the memory location is not set, or transferring the resultant data element to the queue.

33. The machine-readable medium of claim 32, further comprising instructions for:
setting the state indicator of the memory location after the resultant data element is stored in the memory location; and
clearing the state indicator of the memory location after the resultant data element stored in the memory location is added with the data element received into the queue.

34. The machine-readable medium of claim 33, wherein the data element received into the queue comprises one or more input data elements and one or more resultant data elements.

35. The machine-readable medium of claim 34, further comprising instructions for:
receiving the one or more input data elements and the one or more resultant data elements at an end of the queue.

36. The machine-readable medium of claim 35, further comprising instructions for:
adding one of the one or more input data elements or one of the one or more resultant data elements from a head of the queue with the selected stored data element of like precision range to generate the resultant data element.

37. The machine-readable medium of claim 36, further comprising instructions for:
storing the resultant data element in a register of like precision range when a status bit of the register is not set, or transferring the resultant data element to the queue.

38. The machine-readable medium of claim 37, further comprising instructions for:
setting the status bit of the register after the resultant data element is stored in the register; and
clearing the status bit of the register after one of the one or more input data elements or one of the one or more resultant data elements from the head of the queue is added with the resultant data element that was stored in the register.

39. The machine-readable medium of claim 38, further comprising instructions for:
selecting the resultant data element stored in the register of like precision range, wherein the selected resultant data element is added with one of the one or more input data elements or one or more resultant data elements from the head of the queue.

40. The machine-readable medium of claim 39, further comprising instructions for:
adding one of the one or more input data elements or one of the one or more resultant data elements from a head of the queue with the stored resultant data element of like precision range until the queue is empty.

41. In a wireless communications system, an apparatus comprising a processor configured to:
determine a precision range of a data element received into a queue; and
select a stored data element of like precision range, wherein the stored data element is added with the data element received into the queue to generate a resultant data element, the resultant data element stored as a function of like precision range.

42. The system of claim 41, the processor further configured to:
receive the data element into the queue;
add the data element received into the queue with the stored data element of like precision range to generate the resultant data element;
determine whether a state indicator of a memory location of like precision range is set, wherein the state indicator is set after data is stored in the memory location; and
store the resultant data element in the memory location of like precision range when the state indicator of the memory location is not set, or transferring the resultant data element to the queue.

43. The system of claim 42, the processor further configured to:
set the state indicator of the memory location after the resultant data element is stored in the memory location; and
clear the state indicator of the memory location after the resultant data stored in the memory location is added with the data element received into the queue.

44. The system of claim 43, wherein the data element received into the queue comprises one or more input data elements and one or more resultant data elements.

45. The system of claim 44, the processor further configured to receive the one or more input data elements and the one or more resultant data elements at an end of the queue.

46. The system of claim 45, the processor further configured to add one of the one or more input data elements or one of the one or more resultant data elements from a head of the queue with the selected stored data element of like precision range to generate the resultant data element.

47. The system of claim 46, the processor further configured to store the resultant data element in a register of like precision range when a status bit of the register is not set, or transfer the resultant data element to the queue.

48. The system of claim 47, the processor further configured to:
set the status bit of the register after the resultant data element is stored in the register; and
clear the status bit of the register after one of the one or more input data elements or one of the one or more resultant data elements from the head of the queue is added with the resultant data element that was stored in the register.

49. The system of claim 48, the processor further configured to select the resultant data element stored in the register of like precision range, wherein the selected resultant data element is added with one of the one or more input data elements or one or more resultant data elements from the head of the queue. cm 50. The system of claim 49, the processor further configured to add one of the one or more input data elements or one of the one or more resultant data elements from a head of the queue with the stored resultant data element of like precision range until the queue is empty.
